(19) United States
(12) Patent Application Publication
(10) Pub. No.: US 2009/0289777 A1
(43) Pub. Date: Nov. 26, 2009

(54) Arrangement for Increasing the Reading and Writing Integrity of RFID Labels

(76) Inventors: Wilfried Goll, Radolfzell (DE); Torsten Tanz, Hilzingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/470,835

(22) Filed: May 22, 2009

(30) Foreign Application Priority Data
May 26, 2008 (DE) 10 2008 025 144.5

(51) Int. Cl. H04Q 5/22

(52) U.S. Cl. 340/10.51

(57) ABSTRACT

An arrangement is provided for increasing the reading and writing integrity of RFID labels which are fastened, in particular, to piece goods of the type which lie on a flat support by way of at least one preferably flat supporting side which forms a possible fastening plane for the RFID labels, such as a parallelepiped-shaped piece good or the like. In order to ensure inexpensively and simply the predominantly automatic reading and writing of the RFID label irrespective of the position and orientation of the piece good on its support, it is proposed that the RFID label is arranged in at least two adjacent planes of the piece good which differ from one another, to which end the label is bent out of a first fastening plane about at least one edge of the piece good, which edge delimits the possible supporting side, into at least one second fastening plane.

### CROSS REFERENCE TO RELATED APPLICATIONS

This application claims priority of German application No. 10 2008 025 144.5 DE filed May 26, 2008, which is incorporated by reference herein in its entirety.

### FIELD OF INVENTION

The invention relates to an arrangement for increasing the reading and writing integrity of RFID labels which are fastened, in particular, to piece goods of the type which lie on a flat support by way of at least one preferably flat supporting side which forms a possible fastening plane for the RFID labels, such as a parallelepiped-shaped piece good or the like.

### BACKGROUND OF INVENTION

RFID labels are used, inter alia, in order to provide piece goods with information which can be read or written and is required for the transport destinations or the sorting operations. Said labels are predominantly fastened on the piece good by adhesive bonding, and, on account of their information density and capability of being written to, are increasingly replacing stickers which are printed with barcodes and in comparison with which the RFID labels have considerable advantages. One essential advantage in the use of RFID labels comprises the fact that they can be “read and written to” irrespective of their position in relation to the reading unit. This advantage is restricted only by the fact that the RFID label can also be situated on the underside of the labeled piece good, for example of a package. This is the case, in particular, if said piece goods are unloaded automatically and a preferred position, in which the label is not attached on the underside, cannot be produced manually. Here, the underside denotes that side with which the piece good lies on any support. In general, supports of this type are formed by the respectively used conveying or sorting means, such as belt conveyors or carriages of a sorter. If said supports are not configured specially, it is not possible to use the RFID label to identify those goods in the case of which the RFID label is situated on the underside.

Three possible solutions for this problem have been known up to now:

In the first solution approach, the belt or roller conveyor, on which the RFID label is to be read/written, is manufactured from a special material which is permeable for the electromagnetic waves which are required for reading and writing.

The second approach comprises sorting out the unread goods and postprocessing them manually.

The third option comprises the manual alignment of the goods, with the result that the side of the good having the adhesively bonded RFID label is not positioned as underside.

### SUMMARY OF INVENTION

The invention has set itself the object of affording an inexpensive and simple solution for the above-described problem, which solution is suitable for ensuring the predominantly automatic reading and writing of the RFID label irrespective of the position and orientation of the piece good on its support.

In order to achieve the object, it is proposed according to the invention that the RFID label is arranged in at least two adjacent fastening planes of the piece good which differ from one another, to which end the label is bent out of one of its first fastening planes about at least one edge of the piece good, which edge delimits the possible supporting side, into at least one second fastening plane.

The attachment of only one RFID label to two sides of the piece good ensures that at least one part of the label is always not situated on the underside or the supporting side of the piece good.

The RFID label is preferably equipped with a flexible antenna which is deflected into the fastening planes. RFID labels of this type having flexible antennas are already known in the marketplace nowadays, and they are particularly well suited for implementing the label arrangement according to the invention.

As an alternative, it is proposed that one RFID label is equipped with at least two antennas which are arranged on the piece good in each case in different fastening planes. At least one of the antennas can be activated depending on the position of the piece good on the support.

In every case, the attachment of the RFID label over an edge of the piece good or in two adjacent fastening planes ensures that one part of the label is always not situated on the underside of the good.

If only one antenna is used which is bent flexibly into the adjacent planes, it has to be ensured that a part of the RFID label which is sufficient for reading and/or writing, preferably 50% of the label surface which is equipped with the antenna, is situated in one of the fastening planes which can be read. This is intended to achieve a situation where the transmitting/receiving power is sufficient for a reliable transmission even if a part of the label is covered on the underside of the piece good.

When labeling parallelepiped-shaped piece goods, such as packages or the like, the RFID label having the antenna or the antennas can also be arranged in three converging fastening planes in one refinement of the invention. The three-sided label then has the shape of a “corner cap”. In the case of goods which are not parallelepiped-shaped, for example luggage items, a three-dimensional configuration of the RFID label is likewise appropriate and possible.

Elimination of the manual complexity of positioning and postprocessing of the piece good parts can be expected by way of the invention. It is no longer required to configure conveying or sorting devices from special materials which are permeable for electromagnetic waves. Only one RFID label is required which can be applied to the good in one operation. In all positions, in which no RFID label portion is situated on the underside (supporting side) of the good, improved reading and writing properties are to be expected by the “doubling” of the RFID label antenna surface area. With the increase of the antenna surface area or the use of a second antenna in an RFID label, only marginally higher label unit costs are nevertheless produced, since the antenna is a passive component.

### BRIEF DESCRIPTION OF THE DRAWINGS

The drawing diagrammatically shows the arrangement according to the invention of the RFID label on a package.

FIG. 1 shows the package with the attached RFID label, lying on a support, and

FIG. 2 shows the same package, rotated by 90°.

### DETAILED DESCRIPTION OF INVENTION

The piece good, a parallelepiped-shaped package in the example, is denoted by 1 in both figures of the drawing. The package 1 lies on a flat support 2 which is formed, for example, by the circulating belt of a piece goods conveyor. The package has six side faces which in each case form possible fastening planes for an RFID label 6. One of the fastening planes is formed by that side face 3 (upper side) of the package 1 which lies opposite the supporting face of the package 1 on the support 2.

The side face 4 which faces the observer of the drawing is arranged in a second possible fastening plane which extends at a right angle with respect to the plane of the side face 3, the side faces 3 and 4 being delimited by the common edge 5. The further possible fastening planes are represented by the remaining four side faces of the package. For the description of the invention, only the fastening planes (side faces 3 and 4) which are necessary to understand the invention will be described in the following text.

One half 6a of the RFID label 6 is adhesively bonded on the side face 3 which forms the upper side of the package 1; its other half 6b is adhesively bonded on the side face 4 around the edge 5.

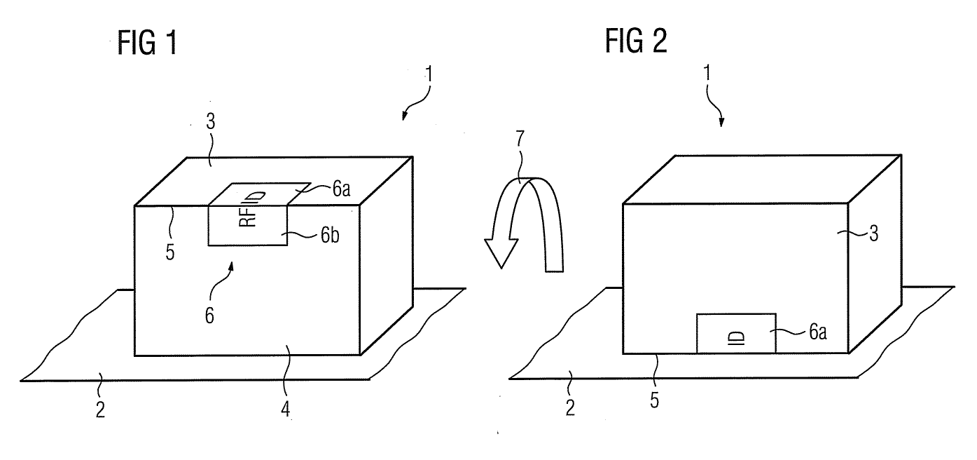

If the package 1 is deposited on the support 2 rotated by 90° in the arrow direction 7, as shown in FIG. 2, the upper side of the package (side face 3) becomes the side face which faces the observer of the drawing; the side face 4 (FIG. 1) lies on the support 2 in an unseen manner and forms the supporting face of the piece good. Here, the half 6b of the RFID label 6 is positioned on the underside (supporting side) of the package, which for its part lies on the support 2. In this position, that part 6b of the RFID label 6 which is covered by the package 1 is no longer reached by the electromagnetic waves of the reading device (not shown) which is provided above the support 2 and the package 1 to the side of the latter or over the latter. Since, however, according to the invention the second half 6a of the RFID label which is equipped with the antenna has been fastened on the side face 3 of the package 1, guided around the edge 5, this part of the RFID label can be reached via the antenna arranged therein or the part region of the antenna, with the result that it is also possible in this position of the package 1 to read or write information.

1.-5. (canceled)

6. An arrangement for increasing the reading and writing integrity of RFID labels which are fastened to a piece good of the type which lie on a flat support, comprising:
an RFID label arranged in a plurality of different fastening planes of the piece good, the plurality of different fastening planes comprising a first fastening plane and a second fastening plane, the RFID label arranged such that a first end of the RFID label is attached to the first fastening plane and is bent about at least one edge of the piece good and a second end of the RFID label is attached to the second fastening plane, the at least one edge is between the first and second fastening planes.

7. The arrangement as claimed in claim 6, wherein the edge delimits the supporting side.

8. The arrangement as claimed in claim 6, wherein the RFID label is equipped with a flexible antenna which is deflected into the first and second fastening planes.

9. The arrangement as claimed in claim 6, wherein the RFID label is equipped with a flexible antenna which is deflected into the plurality of fastening planes.

10. The arrangement as claimed in claim 6, wherein the RFID label is equipped with a plurality of antennas such that at least one antenna is arranged on each of the plurality of fastening planes.

11. The arrangement as claimed in claim 6, wherein the RFID label is equipped with at least two antennas such that at least one of the antennas is in the first fastening plane and that at least one of the antennas is in the second fastening plane.

12. The arrangement as claimed in claim 6, wherein a part of the RFID label which is sufficient for reading and/or writing is situated in the first or second fastening planes.

13. The arrangement as claimed in claim 12, wherein the part of the RFID label which is sufficient for reading and/or writing includes 50% of the label surface which is equipped with the antenna.

14. The arrangement as claimed in claim 9, wherein when the piece good is a parallelepiped-shaped piece good, the RFID label is arranged with the antenna in three converging fastening planes.

15. The arrangement as claimed in claim 10, wherein when the piece good is a parallelepiped-shaped piece good, the RFID label is arranged with the antenna or the antennas in three converging fastening planes.

16. The arrangement as claimed in claim 11, wherein when the piece good is a parallelepiped-shaped piece good, the RFID label is arranged with the antenna or the antennas in three converging fastening planes.
